(19) United States
(12) Patent Application Publication
(10) Pub. No.: US 2009/0087688 A1
(43) Pub. Date: Apr. 2, 2009

(54) IRON NITRIDE POWDER, METHOD OF MANUFACTURING THE SAME, AND MAGNETIC RECORDING MEDIUM

(75) Inventor: Kouichi Masaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/240,483

(22) Filed: Sep. 29, 2008

(30) Foreign Application Priority Data
Sep. 28, 2007 (JP) 2007-256673

(51) Int. Cl. G11B 5/708; H01F 1/032; B05D 3/02

(52) U.S. Cl. 428/842.6; 252/62.55; 252/62.56; 427/318

(57) ABSTRACT

An aspect of the present invention relates to an iron nitride powder. The iron nitride powder is comprised chiefly of Fe₁₆N₂ and comprises, on at least a portion of the powder surface, a coating layer comprising at least one element selected from the group consisting of rare earth metal elements, aluminum, and silicon, and cobalt-containing ferrite having a composition denoted by (CoₓFe₁₋ₓ)Fe₂O₄, wherein 0<x≦1. The present invention further relates to a method of manufacturing iron nitride powders and a magnetic recording medium comprising the iron nitride powder.

### CROSS-REFERENCE TO RELATED APPLICATIONS

This application claims the benefit of priority under 35 USC 119 to Japanese Patent Application No. 2007-256673 filed on Sep. 28, 2007, which is expressly incorporated herein by reference in its entirety.

### BACKGROUND OF THE INVENTION

1. Field of the Invention

The present invention relates to an iron nitride powder that is suitable for use as a ferromagnetic powder in magnetic recording media for high-density recording, and a method of manufacturing the same. The present invention further relates to a magnetic recording medium suitable for use in high-density recording.

2. Discussion of the Background

Means of rapidly transmitting information at the terabyte level have advanced markedly in recent years, making it possible to transfer data and images comprising huge amounts of information. As techniques of transferring data have improved, a need has developed for higher recording capacity in recording and reproduction devices and in recording media for recording, reproducing, and storing information.

Magnetic tapes are employed in a variety of applications, such as audio tapes, video tapes, and computer tapes. In the field of data backup tapes, in particular, as the capacity of the hard disks being backed up has increased, products with recording capacities of several tens to 800 GB per roll have been developed. Backup tapes with capacities exceeding 1 TB have been proposed, and the achievement of high recording capacity in such tapes is essential.

The improvement of magnetic powder is being examined as an approach to achieving high-recording capacity from the magnetic recording medium manufacturing side. For example, the use of iron nitride powders comprising an Fe₁₆N₂ phase as magnetic powder is proposed. For example, WO 03/79332 (Reference 1), Japanese Unexamined Patent Publication (KOKAI) No. 2004-47088 (Reference 2) or English language family member US 2005/0142386 A1, and Japanese Unexamined Patent Publication (KOKAI) No. 2004-335019 (Reference 3) propose such use. The contents of these applications are expressly incorporated herein by reference in their entirety.

Despite being suited to high-density recording due to a high saturation magnetization, the above iron nitride powders require improvement due to poor stability over time such as marked recording demagnetization. Accordingly, forming a coating layer on the surface of the iron nitride particles is proposed to enhance their storage stability. Japanese Unexamined Patent Publication (KOKAI) No. 2005-93570 (Reference 4), Japanese Unexamined Patent Publication (KOKAI) No. 2006-222357 (Reference 5), Japanese Unexamined Patent Publication (KOKAI) No. 2005-268389 (Reference 6) or English language family member US 2005/0208320 A1 propose such attempt. The contents of these applications are expressly incorporated herein by reference in their entirety. Japanese Unexamined Patent Publication (KOKAI) No. 2006-41210 (Reference 7), which is expressly incorporated herein by reference in its entirety, proposes low-temperature nitrogenation following the incorporation of a transition metal into the ferromagnetic metal portion to obtain an iron nitride powder with good weatherability.

In recent years, the use of highly sensitive magnetoresistive heads (referred to as “MR heads” hereinafter) in magnetic recording and reproduction systems has been proposed for the reproduction of signals recorded at high densities, and such use has been put into practice. MR heads afford high sensitivity and are thus suited to the reproduction of signals that have been recorded at high density. Conversely, they also end up detecting medium noise with high sensitivity, so the reduction of noise is important in improving the S/N ratio. In reducing medium noise, the use of microgranular magnetic material is desirable. However, investigation by the present inventor has revealed that when the particle size of the iron nitride powders described in above-cited References 4 to 6 is decreased, the level of demagnetization increases following storage under hot and humid conditions, and decrease of size in the iron nitride powder described in Reference 7 is accompanied by a reduction in saturation magnetization.

### SUMMARY OF THE INVENTION

Accordingly, an aspect of the present invention provides for an iron nitride powder that affords good magnetic characteristics, is stable over time, and is suited to high-density recording.

The present inventor conducted extensive research into achieving the above iron nitride powder, resulting in the following discoveries.

With the iron nitrides described in References 4 to 6, nitrogenation is conducted in a state where the particle surface is covered with a coating layer such as a layer of sintering-preventing agent. Thus, poor uniformity of nitrogenation is achieved, and the coercivity distribution deteriorates. Magnetite formed on a surface by a gradual oxidation treatment contains both divalent and trivalent iron ions, so electrons move between the divalent and trivalent ions. This is thought to be the cause of the high level of demagnetization that occurs following storage.

Reference 7 proposes the improvement of stability over time by forming a layer of nonmagnetic inorganic material by aqueous treatment after the generation of iron nitride comprised chiefly of Fe₁₆N₂. However, when the particle size is decreased in such iron nitride, the nonmagnetic material comprises a larger ratio of the particles as a whole. This is thought to be why saturation magnetization decreases when the particle size of the iron nitride powder described in Reference 7 is decreased.

Accordingly, the present inventor thought of providing gaps in some of the particle surfaces by not completely covering them with sintering-preventing agent during the sintering prevention treatment, and then conducting nitrogenation. When such gaps were provided, nitrogen was introduced into the interior of the particle through the gap, permitting good nitrogenation. However, it was undesirable from the perspective of storage to employ the powder in a medium with the gap still present. Accordingly, the present inventor conducted further research, resulting in the discovery that when cobalt-containing ferrite was adhered to the surface of the iron nitride particles following nitrogenation, iron nitride powder having a good storage property could be obtained.

The present invention was devised on the basis of this discovery.

An aspect of the present invention relates to an iron nitride powder, which is comprised chiefly of Fe₁₆N₂ and comprises, on at least a portion of the powder surface, a coating layer comprising at least one element selected from the group consisting of rare earth metal elements, aluminum, and silicon, and cobalt-containing ferrite having a composition denoted by (CoₓFe₁₋ₓ)Fe₂O₄, wherein 0<x≦1.

The iron nitride powder may have an average particle diameter ranging from 10 to 25 nm.

The iron nitride powder may have a coercivity ranging from 143 to 279 kA/m.

The iron nitride powder may have a saturation magnetization ranging from 55 to 110 A·m/kg.

Another aspect of the present invention relates to a method of manufacturing iron nitride powders, comprising:

subjecting iron oxide powders and/or iron hydroxide powders to a sintering prevention treatment, a reduction, and a nitrogenation, in this order, wherein

the sintering prevention treatment is conducted so that upon completion of the sintering preventing treatment, a sintering-preventing agent coverage rate on the surface of the iron nitride powder is equal to or more than 50 percent but less than 100 percent, and the method further comprising:

adhering cobalt-containing ferrite having a composition denoted by (CoₓFe₁₋ₓ)Fe₂O₄, wherein 0<x≦1, on the surface of the powder following the nitrogenation.

A further aspect of the present invention relates to a magnetic recording medium comprising a magnetic layer comprising a ferromagnetic powder and a binder on a nonmagnetic support, wherein the ferromagnetic powder is the above iron nitride powder.

A still further aspect of the present invention relates to a magnetic recording medium comprising a magnetic layer comprising a ferromagnetic powder and a binder on a nonmagnetic support, wherein

the ferromagnetic powder is the iron nitride powder manufactured by the above method.

The present invention can provide a magnetic recording medium with good stability over time when stored under hot, humid conditions and with good coercivity (Hc) distribution.

Other exemplary embodiments and advantages of the present invention may be ascertained by reviewing the present disclosure.

### DETAILED DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Iron Nitride Powder

The iron nitride powder of the present invention is comprised chiefly of Fe₁₆N₂ and comprises, on at least a portion of the powder surface, a coating layer comprising at least one element selected from the group consisting of rare earth metal elements, aluminum, and silicon, and cobalt-containing ferrite having a composition denoted by (CoₓFe₁₋ₓ)Fe₂O₄ (O<x≦1).

The iron nitride powder of the present invention is comprised chiefly of Fe₁₆N₂. The iron nitride powder comprised chiefly of Fe₁₆N₂ has a high saturation magnetization and is suited to high-density recording. In the present invention, the phrase “is comprised chiefly of Fe₁₆N₂” means that a profile indicating an Fe₁₆N₂ phase is exhibited in X-ray diffraction and the content of nitrogen relative to iron falls within a range of 7.0 to 14 atomic percent. The content of nitride can be measured by fluorescence X-ray analysis, X-ray electron spectroscopy, or with a nitrogen analyzer.

The ratio of nitrogen to iron in Fe₁₆N₂ is 12.5 atomic percent. The fact that the content of nitrogen relative to iron is equal to or greater than 7.0 atomic percent but less than 12.5 atomic percent means that non-nitrogenated iron particles are contained along with Fe₁₆N₂, and greater than 12.5 atomic percent but equal to or less than 14.0 atomic percent means that a small quantity of polynitrides is present along with Fe₁₆N₂. In the iron nitride powder, the content of nitrogen relative to iron desirably falls within a range of 10.0 to 13.0 atomic percent, with the composition preferably being close to Fe₁₆N₂. The iron nitride phase contained in the iron nitride powder is comprised chiefly of Fe₁₆N₂ phase, but does not have to be comprised entirely of Fe₁₆N₂, and may be a mixed phase of Fe₁₆N₂ phase and α-Fe phase. It may also comprise Fe₃N phase and Fe₄N phase. Further, the iron nitride powder may comprise a core portion (inner layer) in the form of an iron nitride phase exhibiting ferromagnetism and the above-described coating layer as an outer layer. An oxide layer formed by a gradual oxidation treatment may be present between the core portion and the coating layer.

A coating layer comprising at least one element selected from the group consisting of rare earth metal elements, aluminum, and silicon, and cobalt-containing ferrite having a composition denoted by (CoₓFe₁₋ₓ)Fe₂O₄ (0<x≦1) is present on at least a portion of the surface of the iron nitride powder of the present invention. The fact that the iron nitride powder comprising the above coating layer can have good dispersibility, so dispersion when forming the magnetic layer can be readily achieved, and a magnetic layer of good surface smoothness can be formed was discovered for the first time by the present inventor. The presence of the above-described coating layer can be confirmed by the following method. When the iron nitride powder is pressed and the surface elements are analyzed by X-ray photoelectron spectrometry, the above-described elements and the Co and Fe constituting the above ferrite are detected. When elemental analysis is conducted while etching, the signals of these elements attenuate and they become constant values. Thus, the presence of the layer comprising the above-described elements, Co, and Fe can be confirmed as the surface coating layer. The composition of the cobalt-containing ferrite in the powder becomes nearly identical to the composition when added based on the reaction formula.

The cobalt-containing ferrite has a composition denoted by (CoₓFe₁₋ₓ) Fe₂O₄. In the formula, X denotes 0<X≦1, desirably ranging from 0.5 to 1.0 and preferably ranging from 0.75 to 1.0. There is little divalent Fe in the ferrite, so few electrons move back and forth between the divalent Fe and trivalent Fe, resulting in little demagnetization during storage under hot, humid conditions. However, when X exceeds 1, epitaxial growth of (CoₓFe₁₋ₓ) Fe₂O₄ tends not to occur on the iron oxide layer formed by gradual oxidation. Specifically, the ferrite can be CoFe₂O₄ or the like. The manufacturing method of the present invention, described further below, can yield an iron nitride powder in which the covering layer is comprised chiefly of a sintering-preventing agent and the above ferrite is formed on portions not covered with the sintering-preventing agent.

The iron nitride powder of the present invention comprises at least one element selected from the group consisting of rare earth metal elements, aluminum, and silicon in at least a surface coating layer. The above elements are at least present in the outer layer, but some portion thereof may be present elsewhere. The above elements can be added primarily as sintering-preventing agents. When present in excessively low quantity, there may be little dispersion-enhancing effect and the form-retaining effect during reduction may diminish. Conversely, when present in excessively high quantity, the portion of the above elements that remains unreacted may increase, coercivity and saturation magnetization sometimes drop precipitously, and there may be cases when medium manufacturing is impeded, such as in the dispersion and coating steps. When the above-described points are considered, the total quantity of rare earth metal elements, aluminum, and silicon in the iron nitride powder is desirably 3 to 30 atomic percent, preferably 5 to 25 atomic percent, relative to the iron.

The iron nitride powder of the present invention also comprises cobalt-containing ferrite in the coating layer. The content of cobalt in the powder becomes about the same as the quantity in the formula.

The quantity of the above elements can be measured by fluorescence X-ray analysis, X-ray electron spectroscopy, and the like.

The coating layer need only be present on at least a portion of the surface of the iron nitride powder, but the entire surface is desirably covered with the coating layer. When the coating layer is too thin, the sintering-preventing effect may be inadequate, making it difficult to effectively inhibit sintering between particles. When too thick, the magnetic portion diminishes, sometimes making it difficult to obtain an iron nitride powder of adequate magnetic characteristics. From these perspectives, the coating layer is desirably 0.5 to 3.0 nm, preferably 0.7 to 2.5 nm, in thickness.

The iron nitride powder of the present invention may further comprise an iron oxide film (oxide coating film) between the iron nitride phase and the coating layer. By way of example, the iron oxide film can be formed by the gradual oxidation treatment described further below. The iron oxide film can be about 0.3 to 1.5 nm in thickness, for example.

The average particle diameter of the iron nitride powder desirably ranges from 10 to 25 nm and preferably ranges from 10 to 20 nm. When the average particle diameter is equal to or greater than 10 nm, adequate magnetic characteristics can be achieved. When the average particle diameter is equal to or less than 25 nm, a magnetic layer of good surface smoothness can be readily obtained, and a magnetic recording medium exhibiting low noise and good electromagnetic characteristics can be obtained. Further, the surface area of the iron nitride powder is desirably 30 to 90 m²/g, preferably 35 to 80 m²/g, as a specific surface area by BET method.

The average particle size in the present invention is the average size of 500 particles as measured based on a photograph (with a magnification of 500,000-fold, for example) taken by transmission electron microscope (TEM). Specifically, the average particle diameter is the average diameter of the particles as calculated by the above method. The average particle diameter of the iron nitride powder refers to the size of all of the particles contained in the coating layer, oxide film, and other layers.

The preferred magnetic characteristics of the iron nitride powder are as follows. The saturation magnetization (σs) desirably falls within a range of 55 to 110 A·m²/kg. When σs is equal to or higher than 55 A·m²/kg, a high-strength signal can be obtained, and when equal to or less than 110 A·m¹/kg, good recording can be conducted without magnetically affecting adjacent recorded bits during in-plane recording. The as desirably falls within a range of 60 to 100 A·m²/kg.

The coercivity (Hc) of the iron nitride powder is desirably 143 to 279 kA/m (approximately 1,800 to 3,500 Oe). When the Hc is equal to or greater than 143 kA/m, good recording can be conducted without magnetically affecting adjacent recorded bits during in-plane recording, and equal to or less than 279 kA/m is suitable for high-density recording. The Hc desirably ranges from 170 to 250 kA/m.

Since the iron nitride powder of the present invention can have improved Hc distribution, it can exhibit little demagnetization following storage under hot, humid conditions and afford good stability over time. The iron nitride powder of the present invention can exhibit good stability over time, such as a demagnetization of equal to or less than −10 percent when stored at 90 percent RH at 60° C.

The iron nitride powder of the present invention as set forth above can be obtained by the method of manufacturing iron nitride powders of the present invention described below. However, the iron nitride powder of the present invention is not limited to the powder obtained by the method of manufacturing iron nitride powders of the present invention.

### Method of Manufacturing Iron Powders

The method of manufacturing iron nitride powders of the present invention comprises:

subjecting iron oxide powders and/or iron hydroxide powders to a sintering prevention treatment, a reduction, and a nitrogenation, in this order, wherein

the sintering prevention treatment is conducted so that upon completion of the sintering preventing treatment, a sintering-preventing agent coverage rate on the surface of the iron nitride powder is equal to or more than 50 percent but less than 100 percent. The method further comprises adhering cobalt-containing ferrite having a composition denoted by (CoₓFe₁₋ₓ) Fe₂O₄ (wherein 0<x≦1) on the surface of the powder following the nitrogenation.

When nitrogenating a particle the surface of which has not been completely covered by sintering-preventing agent, the nitrogenation can proceed smoothly, yielding iron nitride powder of good coercivity distribution. Further, adhering cobalt-containing ferrite to the surface of the particle following nitrogenation can enhance the storage property under hot, humid conditions. The coating layer that is formed in the above step, as set forth above, can also have the effect of enhancing the dispersibility of the iron nitride powder. That is, the method of manufacturing iron nitride powders of the present invention can provide iron nitride powders in the form of microparticles of good dispersibility.

In the present invention, the term “sintering-preventing agent coverage rate” is calculated by assuming that one layer of unit cells of oxides of rare earth elements, SiO₂, and/or α-Al₂O₃ is present on the surface, calculating the surface areas of the various oxides based on the quantity of sintering-preventing agent added, and dividing the total thereof by the specific surface area of the ferromagnetic metal. When a sintering-preventing agent coverage rate of equal to or greater than 50 percent but less than 100 percent, desirably 60 to 90 percent, is achieved, nitrogenation can be kept to a composition close to Fe₁₆N₂. By contrast, when the sintering-preventing agent coverage rate is less than 50 percent, the sintering-preventing effect is inadequate and pronounced sintering occurs between particles. When the sintering-preventing agent coverage rate is equal to or higher than 100 percent, the uniformity of the nitrogenation reaction deteriorates and the Hc distribution increases. The sintering-preventing agent coverage rate can be controlled by adjusting the quantity of sintering-preventing agent employed based on the size of the starting material powder.

In the present invention, since the term “sintering-preventing agent coverage rate” is a value that is calculated premised on the presence of one layer of unit cells as set forth above, it can sometimes exceed 100 percent.

The method of manufacturing iron nitride powders of the present invention will be described in greater detail below.

### Starting Material Particles

Iron oxide particles and/or iron hydroxide particles, such as hematite, goethite, and magnetite, can be employed as starting material particles. The shape of the starting material particles is desirably an isotropic shape, such as cubic or spherical. The starting material particles can be synthesized or obtained as a commercial product for use. The present inventor discovered that eliminating alkali metals during manufacturing was effective for obtaining microgranular iron nitride powder. Accordingly, when employing a commercial product as the starting material particle, it is desirable to employ particles in which the alkali metal content has been reduced. When necessary, treatments to reduce alkali metals, such as washing, can be conducted. For both commercial products and synthesized products, the alkali metal content of the product employed is desirably equal to or lower than 0.02 weight percent, preferably 0 to 0.02 weight percent. The content of alkali components can be determined by ICP, the atomic absorption method, or the like. The average particle diameter of the starting material particle is desirably equal to or greater than 10 nm from the perspectives of preventing sintering and ensuring the magnetization level, and is desirably equal to or less than 30 nm from the perspective of obtaining a microgranular iron nitride powder.

When synthesizing the starting material particle, it is desirable to adopt a synthesis method that does not employ alkali metal components. An example of such a synthesis method is the method of synthesizing magnetite particles by conducting a neutralization treatment in an iron salt aqueous solution containing an iron (II) salt and/or an iron (III) salt to form particles, optionally subjecting the particles that have been formed to an oxidation treatment and/or reduction treatment to obtain magnetite particles, and employing the magnetite particles that have been obtained as the above described iron oxide particles. The above neutralization treatment can be conducted by adding at least one aqueous solution selected from the group consisting of ammonia water, an ammonium salt aqueous solution, and a urea aqueous solution to the above iron salt aqueous solution. The method of synthesizing magnetite particles will be described below.

The iron salt aqueous solution employed can contain an iron salt in the form of an iron (II) salt (ferrous salt) or an iron (III) salt (ferric salt), or can contain both an iron (II) salt and an iron (III) salt.

Examples of the iron salt are sulfates, nitrates, and chlorides. Hydrates thereof may also be employed. The concentration of the iron salt can be adjusted to, for example, 0.01 to 0.5 mol/L, desirably 0.02 to 0.3 mol/L. When employing an iron (II) and iron (III) salt in combination, the mixing ratio, employing a molar standard, can be iron (II) salt:iron (III) salt=1:1 to 1:2, for example.

In the above method of synthesizing magnetite particles, at least one aqueous solution selected from the group consisting of ammonia water, an ammonium salt aqueous solution, and a urea aqueous solution is employed in the neutralization processing of the iron salt aqueous solution. Conducting a neutralization reaction without employing an alkali metal hydroxide such as sodium hydroxide in this manner can yield a magnetite particle that does not contain alkali metal. Following the neutralization reaction, a known hydrothermal treatment or maturing reaction conducted in solution can be conducted to control the particle size or enhance crystallinity.

The concentration of the aqueous solution employed in neutralization can be set based on the concentration of the iron salt aqueous solution to adjust the pH to about 8 to 10. For example, when employing urea, the urea is desirably added in a quantity of 2.5 to 10-fold the iron salt neutralization equivalent. The concentration of ammonia water or an ammonium salt aqueous solution is desirably 5 to 20 weight percent. An ammonium salt in the form of ammonium carbonate, ammonium hydrogencarbonate, ammonium phosphonate, ammonium hydrogenphosphonate, ammonium phosphate, or the like can be employed.

Magnetite particles can be obtained through a neutralization reaction when an aqueous solution containing an iron (II) salt and an iron (III) salt is employed as the iron salt aqueous solution.

When employing an iron (II) salt aqueous solution as the iron salt aqueous solution, the above neutralization reaction can cause ferrous hydroxide to precipitate. In this case, the ferrous hydroxide obtained can be subjected to an oxidation treatment to obtain magnetite particles. The oxidation treatment can be conducted, for example, by introducing air into a suspension in which ferrous hydroxide has precipitated due to a neutralization reaction; heating the suspension; and maintaining the suspension for a prescribed period. The heating temperature can be about 40 to 70° C., for example, and the maintaining period can be about 30 to 180 minutes.

When employing an iron (III) salt aqueous solution as the iron salt aqueous solution, the above neutralization reaction can cause ferric hydroxide to precipitate. In this case, the ferric hydroxide obtained can be subjected to a reduction to obtain magnetite particles. For the reduction, reference can be made in, for example, Japanese Unexamined Patent Publication (KOKAI) Heisei No. 8-325098 or the like, which is expressly incorporated herein by reference in its entirety.

In both of the above cases, the solution into which the magnetite particles have precipitated can be filtered and the magnetite particles recovered can be subjected to a washing process such as water washing as needed to obtain starting material particles.

The sintering-prevention treatment to which the starting material particles are subjected will be described next.

It suffices to conduct the sintering-preventing process so that, upon completion, the sintering-preventing agent coverage rate on the surface of the iron nitride powder is equal to or more than 50 percent but less than 100 percent. The coverage rate can be controlled through the quantity of sintering-preventing agent and the processing temperature.

During the sintering-preventing process of the starting material particles, a sintering-preventing agent can be added to a solution containing the starting material particles. In the course of neutralization by the addition of a neutralizing agent to the solution following the addition of the sintering-preventing agent, at least one neutralizing agent selected from the group consisting of ammonia, carbonic acid gas, and acetic acid is desirably employed. Conducting the sintering-preventing process without using the sodium hydroxide that is normally employed as a neutralizing agent can prevent the introduction of alkali metals into the particles prior to reduction and effectively prevent sintering.

An aqueous solution containing about 2 to 10 weight percent of starting material particles can be employed. The aqueous solution is desirably a dispersion in which particles are dispersed with an ultrasonic disperser or the like.

The sintering-preventing agent that is added to the solution need only have the effect of preventing sintering by adhering to the surface of the particles; examples are rare earth elements, aluminum, and silicon. Of these, yttrium and aluminum are desirable. These sintering-preventing agents are desirably added in a quantity of 1.0 to 40 atomic percent, preferably in a quantity of 4.0 to 30 atomic percent, relative to the iron. Rare earth elements may be added to the solution comprising the starting material particles in the form of nitrates, nitrides, or the like; aluminum in the form of a chloride, sodium salt, nitrate, or the like; and silicon in the form of sodium silicate or the like. Even when the sintering-preventing agent is added in the form of a sodium salt, the sodium can be readily removed prior to reduction by washing, so a quantity on a scale that promotes sintering will not remain in the particles. However, to effectively prevent sintering, it is desirable to not employ an alkali component in the manufacturing process.

Next, one or more neutralizing agents desirably selected from the group consisting of ammonia, carbonic acid gas, and acetic acid can be added to the solution following the addition of the sintering agent. It suffices to determine the quantity of neutralizing agent to adjust the pH. In the case of ammonia, for example, the pH can be adjusted to 7.5 to 9.5, desirably 8.0 to 9.5. In the case of carbonic acid gas, for example, the pH can be adjusted to from 5.5 to 6.5, desirably 5.5 to 6.0. In the case of acetic acid, for example, the pH can be adjusted to 5.5 to 6.5, desirably to 5.5 to 6.0. These neutralizing agents can be added while stirring a solution the temperature of which is being maintained at room temperature or from about 35 to 50° C.

### Reduction and Nitrogenation

Following the above sintering prevention treatment, dehydration and annealing can be conducted as needed. Hydrogen reduction can then be conducted to obtain a ferromagnetic metal powder. A reduction temperature of equal to or higher than 400° C. permits adequate reduction of the interior of the particles, preventing a reduction in the nitrogenation processing rate due to oxygen remaining within the particles. The reduction temperature is desirably equal to or lower than 600° C. so as to prevent sintering from occurring between particles during reduction.

Next, the ferromagnetic metal powder obtained can be nitrogenated. It is desirable to form a quasi-stable phase in the form of an Fe₁₆N₂ phase by low temperature nitrogenation to obtain iron nitride having good magnetic characteristics. When the nitrogenation temperature is too high, nitrogenation advances excessively, increasing the ratio of the Fe₄N and Fe₃N phases, sometimes making it difficult to obtain adequate coercivity and saturation magnetization. However, when the nitrogenation temperature is too low, nitrogenation does not proceed adequately and there is little coercivity-enhancing effect. From these perspectives, the nitrogenation processing temperature desirably falls within a range of 100 to 300° C., desirably within a range of 120 to 200° C.

Next, the iron nitride powder that has been subjected to a slow oxidation treatment as needed can be subjected to a treatment to adhere cobalt-containing ferrite having the composition denoted by (CoₓFe₁₋ₓ) Fe₂O₄ (0<x≦1). The adhesion treatment can be conducted by dispersing the iron nitride powder in an alkali aqueous solution to obtain a slurry, adding the (CoₓFe₁₋ₓ) Fe₂O₄ adhesion starting material while blowing nitrogen into the slurry, adding alkali hydroxide to adjust the alkali concentration, and heating the solution.

The alkali aqueous solution in which the iron nitride powder is dispersed desirably has a pH of 9 to 11. Examples of alkali aqueous solutions that are suitable for use are potassium hydroxide aqueous solutions and sodium hydroxide aqueous solutions with a concentration of 0.001 to 0.1 N. The alkali aqueous solution desirably does not drop to a pH of equal to or less than 6 following addition of the iron nitride powder. At pH of equal to or less than 6, the surface of the iron nitride powder sometimes dissolves.

The concentration of the iron nitride powder in the alkali aqueous solution can be, for example, 2 to 10 weight percent, desirably 3 to 8 weight percent. A slurry can be obtained by subjecting the alkali aqueous solution to which the iron nitride powder has been added to dispersion processing in a disperser such as a sand grinder.

For example, Co salts such as CoSO₄.7H₂O and Co(NO₃)₂.6H₂O; and Fe salts such as FeSO₄.7H₂O, Fe(NO₃)₂.H₂O, Fe₂(SO₄)₃.9H₂O and Fe(NO₃)₃.6H₂O can be employed. The composition of the ferrite that is adhered can be controlled through the blending ratio of Co salt and Fe salt. During adhesion processing, bubbling or the like can be used to blow in nitrogen, converting Fe²⁺ to Fe³⁺ and producing Fe₃O₄, thereby preventing loss of epitaxial growth.

An alkali hydroxide is desirably added to the slurry to which the adhesion starting material has been added to adjust the concentration of alkali. The concentration of alkali in the slurry can be adjusted so that the OH concentration is desirably 0.2 to 5 N, preferably to 0.5 to 2 N.

In the heat treatment of the above slurry, the heating temperature can be, for example, 60 to 100° C., desirably 80 to 100° C., and the treatment can be conducted, for example, for 0.5 to 5 hours, desirably 1 to 3 hours. Following the reaction, the slurry can be cooled, filtered, washed with water, and dried to obtain iron nitride powder the surface of which is coated with cobalt-containing ferrite of the composition denoted by (CoₓFe₁₋ₓ) Fe₂O₄. The details of the ferrite composition formed are as set forth above.

In the manufacturing method of the present invention, since powders that have been coated with a sintering-preventing agent over 50 percent or more but less than 100 percent of its surface is subjected to the above-described adhesion treatment, the adhesion material can react mainly on the surface of those particles that have not been coated with the sintering-preventing agent. Thus, it is presumed that the adhesion treatment can yield a coating layer that is comprised mostly of a film comprised of sintering-preventing agent, with a remainder comprised of the above-described cobalt film.

### Magnetic Recording Medium

The present invention further relates to a magnetic recording medium comprising a magnetic layer comprising a ferromagnetic powder and a binder on a nonmagnetic support. The magnetic recording medium of the present invention comprises a ferromagnetic powder in the form of the iron nitride powder of the present invention or the iron nitride powder manufactured by the manufacturing method of the present invention. Since the magnetic recording medium of the present invention comprises the above-described iron nitride powder, it can exhibit good electromagnetic characteristics and stability over time, and is suitable as a magnetic recording medium for high-density recording.

The magnetic recording medium of the present invention will be described in greater detail below.

### Binder

The magnetic recording medium of the present invention comprises at least a magnetic layer on a nonmagnetic support, may further comprise a nonmagnetic layer between the nonmagnetic support and the magnetic layer, and optionally comprises a backcoat layer on the opposite surface of the nonmagnetic support from the surface on which the magnetic layer is provided. The binders, lubricants, dispersing agents, additives, solvents, dispersion methods, and other known techniques of the magnetic layer, nonmagnetic layer, and backcoat layer can be applied in a mutually suitable manner. In particular, known techniques can be applied to the quantity and type of binder, and the quantity and type of additives and dispersing agents.

Conventionally known thermoplastic resins, thermosetting resins, reactive resins and mixtures thereof may be employed as binders used. The thermoplastic resins suitable for use have a glass transition temperature of −100 to 150° C., a number average molecular weight of 1,000 to 200,000, preferably from 10,000 to 100,000, and have a degree of polymerization of about 50 to 1,000.

Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten, which is expressly incorporated herein by reference in its entirety. It is also possible to employ known electron beam-cured resins in each layer. Examples and manufacturing methods of such resins are described in Japanese Unexamined Patent Publication (KOKAI) Showa No. 62-256219, which is expressly incorporated herein by reference in its entirety. The above-listed resins may be used singly or in combination. Preferred resins are combinations of polyurethane resin and at least one member selected from the group consisting of vinyl chloride resin, vinyl chloride—vinyl acetate copolymers, vinyl chloride—vinyl acetate—vinyl alcohol copolymers, and vinyl chloride—vinyl acetate—maleic anhydride copolymers, as well as combinations of the same with polyisocyanate.

Known polyurethane resins may be employed, such as polyester polyurethane, polyether polyurethane, polyether polyester polyurethane, polycarbonate polyurethane, polyester polycarbonate polyurethane, and polycaprolactone polyurethane. A binder obtained by incorporating as needed one or more polar groups selected from among —COOM, —SO₃M, —OSO₃M, —P═O(OM)₂, and —O—P═O(OM)₂ (where M denotes a hydrogen atom or an alkali metal base), —OH, —NR₂, —N⁺R₃ (where R denotes a hydrocarbon group), epoxy group, —SH, and —CN into any of the above-listed binders by copolymerization or addition reaction to improve dispersion properties and durability is desirably employed. The quantity of such a polar group ranges from 10⁻¹ to 10⁻⁸ mol/g, preferably from 10⁻² to 10⁻⁶ mol/g.

Specific examples of the binders are VAGH, VYHH, VMCH, VAGF, VAGD, VROH, VYES, VYNC, VMCC, XYHL, XYSG, PKHH, PKHJ, PKHC, and PKFE from Dow Chemical Company; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The quantity of binder added to the magnetic layer and the nonmagnetic layer ranges from, for example, 5 to 50 weight percent, preferably from 10 to 30 weight percent, relative to the weight of the nonmagnetic powder or magnetic powder. When employing vinyl chloride resin, the quantity of binder added is preferably from 5 to 30 weight percent; when employing polyurethane resin, from 2 to 20 weight percent; and when employing polyisocyanate, from 2 to 20 weight percent. They may be employed in combination. However, for example, when head corrosion occurs due to the release of trace amounts of chlorine, polyurethane alone or just polyurethane and isocyanate may be employed. When polyurethane is employed, the glass transition temperature ranges from, for example, −50 to 150° C., preferably from 0 to 100° C.; the elongation at break preferably ranges from 100 to 2,000 percent; the stress at break desirably ranges from 0.05 to 10 kg/mm (approximately 0.49 to 98 MPa); and the yield point preferably ranges from 0.05 to 10 kg/mm² (approximately 0.49 to 98 MPa).

Examples of polyisocyanates are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used in each layer singly or in combinations of two or more by exploiting differences in curing reactivity.

Additives may be added to the magnetic layer as needed. Examples of such additives are: abrasives, lubricants, dispersing agents, dispersing adjuvants, antifungal agents, antistatic agents, oxidation inhibitors, solvents, and carbon black. Examples of additives are: molybdenum disulfide, tungsten disulfide, graphite, boron nitride, graphite fluoride, silicone oil, polar group-comprising silicone, fatty acid-modified silicone, fluorosilicone, fluoroalcohols, fluoroesters, polyolefin, polyglycol, polyphenyl ether, phenyl phosphonic acid, benzyl phosphonic acid, phenethyl phosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, other aromatic ring-comprising organic phosphonic acids, alkali metal salts thereof, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, other alkyl phosphonoic acid, alkali metal salts thereof, phenyl phosphoric acid, benzyl phosphoric acid, phenethyl phosphoric acid, α-methylbenzylphosphoric acid, 1-methyl-1-phenethylphosphoric acid, diphenylmethylphosphoric acid, diphenyl phosphoric acid, benzylphenyl phosphoric acid, α-cumyl phosphoric acid, toluyl phosphoric acid, xylyl phosphoric acid, ethylphenyl phosphoric acid, cumenyl phosphoric acid, propylphenyl phosphoric acid, butylphenyl phosphoric acid, heptylphenyl phosphoric acid, octylphenyl phosphoric acid, nonylphenyl phosphoric acid, other aromatic phosphoric esters, alkali metal salts thereof, octyl phosphoric acid, 2-ethylhexylphosphoric acid, isooctyl phosphoric acid, isononyl phosphoric acid, isodecyl phosphoric acid, isoundecyl phosphoric acid, isododecyl phosphoric acid, isohexadecyl phosphoric acid, isooctyldecyl phosphoric acid, isoeicosyl phosphoric acid, other alkyl ester phosphoric acids, alkali metal salts thereof, alkylsulfonic acid ester, alkali metal salts thereof, fluorine-containing alkyl sulfuric acid esters, alkali metal salts thereof, lauric acid, myristic acid, palmitic acid, stearic acid, behenic acid, oleic acid, linolic acid, linoleic acid, elaidic acid, erucic acid, other monobasic fatty acids comprising 10 to 24 carbon atoms (which may contain an unsaturated bond or be branched), metal salts thereof, butyl stearate, octyl stearate, amyl stearate, isooctyl stearate, octyl myristate, butyl laurate, butoxyethyl stearate, anhydrosorbitan monostearate, anhydrosorbitan tristearate, other monofatty esters, difatty esters, or polyfatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched), alkoxyalcohol having 12 to 22 carbon atoms (which may contain an unsaturated bond or be branched) or a monoalkyl ether of an alkylene oxide polymer, fatty acid amides with 2 to 22 carbon atoms, and aliphatic amines with 8 to 22 carbon atoms. Compounds having aralkyl groups, aryl groups, or alkyl groups substituted with groups other than hydrocarbon groups, such as nitro groups, F, Cl, Br, CF₃, CCl₃, CBr₃, and other halogen-containing hydrocarbons in addition to the above hydrocarbon groups, may also be employed.

It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K. K.), which is expressly incorporated herein by reference in its entirety.

These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent.

Specific examples of these additives are: NAA-102, hydrogenated castor oil fatty acid, NAA-42, Cation SA, Nymeen L-201, Nonion E-208, Anon BF and Anon LG manufactured by NOF Corporation; FAL-205 and FAL-123 manufactured by Takemoto Oil & Fat Co., Ltd.; NJLUB OL manufactured by New Japan Chemical Co. Ltd.; TA-3 manufactured by Shin-Etsu Chemical Co. Ltd.; Armide P and Duomine TDO manufactured by Lion Corporation; BA-41G manufactured by Nisshin OilliO, Ltd.; and Profan 2012E, Newpole PE61 and Ionet MS-400 manufactured by Sanyo Chemical Industries, Ltd.

Carbon black may be added to the magnetic layer as needed. Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml.

Specific examples of types of carbon black employed are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Ketjen Black International Co., Ltd. The carbon black employed may be surface-treated with a dispersant or grafted with resin, or have a partially graphite-treated surface. The carbon black may be dispersed in advance into the binder prior to addition to the magnetic coating liquid. These carbon blacks may be used singly or in combination. When employing carbon black, the quantity preferably ranges from 0.1 to 30 weight percent with respect to the weight of the ferromagnetic powder. In the magnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association, which is expressly incorporated herein by reference in its entirety, may be consulted for types of carbon black suitable for use in the magnetic layer.

### Abrasive

Known materials chiefly having a Mohs' hardness of equal to or greater than 6 may be employed either singly or in combination as abrasives. These include: α-alumina with an α-conversion rate of equal to or greater than 90 percent, β-alumina, silicon carbide, chromium oxide, cerium oxide, α-iron oxide, corundum, synthetic diamond, silicon nitride, titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed may be acicular, spherical, cubic, plate-shaped or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the nonmagnetic layer. Addition of abrasives to the nonmagnetic layer can be done to control surface shape, control how the abrasive protrudes, and the like. The particle size and quantity of the abrasives added to the magnetic layer and nonmagnetic layer should be set to optimal values.

Known organic solvents can be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane.

These organic solvents need not be 100 weight percent pure and may contain impurities such as isomers, unreacted materials, by-products, decomposition products, oxides and moisture in addition to the main components. The content of these impurities is preferably equal to or less than 30 weight percent, more preferably equal to or less than 10 weight percent. Preferably the same type of organic solvent is employed in the magnetic layer and in the nonmagnetic layer. However, the amount added may be varied. The stability of coating is increased by using a solvent with a high surface tension (such as cyclohexanone or dioxane) in the nonmagnetic layer. Specifically, it is important that the arithmetic mean value of the magnetic layer solvent composition be not less than the arithmetic mean value of the nonmagnetic layer solvent composition. To improve dispersion properties, a solvent having a somewhat strong polarity is desirable. It is desirable that solvents having a dielectric constant equal to or higher than 15 are comprised equal to or higher than 50 percent of the solvent composition. Further, the dissolution parameter is desirably 8 to 11.

The types and quantities of dispersing agents, lubricants, and surfactants employed in the magnetic layer may differ from those employed in the nonmagnetic layer, described further below, in the present invention. For example (the present invention not being limited to the embodiments given herein), a dispersing agent usually has the property of adsorbing or bonding by means of a polar group. In the magnetic layer, the dispersing agent adsorbs or bonds by means of the polar group primarily to the surface of the ferromagnetic metal powder, and in the nonmagnetic layer, primarily to the surface of the nonmagnetic powder. It is surmised that once an organic phosphorus compound has adsorbed or bonded, it tends not to dislodge readily from the surface of a metal, metal compound, or the like. Accordingly, the surface of a ferromagnetic metal powder or the surface of a nonmagnetic powder becomes covered with the alkyl group, aromatic groups, and the like. This enhances the compatibility of the ferromagnetic metal powder or nonmagnetic powder with the binder resin component, further improving the dispersion stability of the ferromagnetic metal powder or nonmagnetic powder. Further, lubricants are normally present in a free state. Thus, it is conceivable to use fatty acids with different melting points in the nonmagnetic layer and magnetic layer to control seepage onto the surface, employ esters with different boiling points and polarity to control seepage onto the surface, regulate the quantity of the surfactant to enhance coating stability, and employ a large quantity of lubricant in the nonmagnetic layer to enhance the lubricating effect. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

### Nonmagnetic Layer

Details of the nonmagnetic layer will be described below. The magnetic recording medium of the present invention may comprise a nonmagnetic layer comprising a nonmagnetic powder and a binder between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 nm to 500 nm, more preferably from 40 to 100 nm. A crystallite size falling within a range of 4 nm to 500 nm is desirable in that it facilitates dispersion and imparts a suitable surface roughness. The average particle diameter of the nonmagnetic powder preferably ranges from 5 nm to 500 nm. As needed, nonmagnetic powders of differing average particle diameter may be combined; the same effect may be achieved by broadening the average particle distribution of a single nonmagnetic powder. The preferred average particle diameter of the nonmagnetic powder ranges from 10 to 200 nm. Within a range of 5 nm to 500 nm, dispersion is good and good surface roughness can be achieved.

The specific surface area of the nonmagnetic powder preferably ranges from 1 to 150 m²/g, more preferably from 20 to 120 m²/g, and further preferably from 50 to 100 m²/g. Within the specific surface area ranging from 1 to 150 m²/g, suitable surface roughness can be achieved and dispersion is possible with the desired quantity of binder. Oil absorption capacity using dibutyl phthalate (DBP) preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity or due to the freeing of fatty acids. The moisture content of the nonmagnetic powder ranges from, for example, 0.1 to 5 weight percent, preferably from 0.2 to 3 weight percent, and more preferably from 0.3 to 1.5 weight percent. A moisture content falling within a range of 0.1 to 5 weight percent is desirable because it can produce good dispersion and yield a stable coating viscosity following dispersion. An ignition loss of equal to or less than 20 weight percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (approximately 200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders is preferably treated with Al₂O₃, SiO₂, TiO₂, ZrO₂, SnO₂, Sb₂O₃, and ZnO. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders suitable for use in the nonmagnetic layer in the present invention are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, MT-600B, MT-100F and MT-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Carbon black may be combined with nonmagnetic powder in the nonmagnetic layer to reduce surface resistivity, reduce light transmittance, and achieve a desired micro-Vickers hardness. The micro-Vickers hardness of the nonmagnetic layer is normally 25 to 60 kg/mm² (approximately 245 to 588 MPa), desirably 30 to 50 kg/mm² (approximately 294 to 490 MPa) to adjust head contact. It can be measured with a thin film hardness meter (HMA-400 made by NEC Corporation) using a diamond triangular needle with a tip radius of 0.1 micrometer and an edge angle of 80 degrees as indenter tip. “Techniques for evaluating thin-film mechanical characteristics,” Realize Corp., for details. The content of the above publication is expressly incorporated herein by reference in its entirety. The light transmittance is generally standardized to an infrared absorbance at a wavelength of about 900 nm equal to or less than 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer is, for example, 100 to 500 m²/g, preferably 150 to 400 m²/g. The DBP oil absorption capability is, for example, 20 to 400 mL/100 g, preferably 30 to 200 mL/100 g. The particle diameter of the carbon black is, for example, 5 to 80 nm, preferably 10 to 50 nm, and more preferably, 10 to 40 nm. It is preferable that the pH of the carbon black is 2 to 10, the moisture content is 0.1 to 10 percent, and the tap density is 0.1 to 1 g/mL.

Specific examples of types of carbon black employed in the nonmagnetic layer are: BLACK PEARLS 2000, 1300, 1000, 900, 905, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Ketjen Black International Co., Ltd.

The carbon black employed may be surface-treated with a dispersant or grafted with resin, or have a partially graphite-treated surface. The carbon black may be dispersed in advance into the binder prior to addition to the nonmagnetic coating liquid. These carbon blacks may be used singly or in combination. When employing carbon black, the quantity of the carbon black is preferably within a range not exceeding 50 weight percent of the inorganic powder as well as not exceeding 40 weight percent of the total weight of the nonmagnetic layer. For example, the Carbon Black Handbook compiled by the Carbon Black Association, which is expressly incorporated herein by reference in its entirety, may be consulted for types of carbon black suitable for use in the nonmagnetic layer.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of the above applications are expressly incorporated herein by reference in their entirety.

Binders, lubricants, dispersing agents, additives, solvents, dispersion methods, and the like suited to the magnetic layer may be adopted to the nonmagnetic layer. In particular, known techniques for the quantity and type of binder and the quantity and type of additives and dispersion agents employed in the magnetic layer may be adopted thereto.

An undercoating layer can be provided in the magnetic recording medium of the present invention. Providing an undercoating layer can enhance adhesive strength between the support and the magnetic layer or nonmagnetic layer. For example, a polyester resin that is soluble in solvent can be employed as the undercoating layer to enhance adhesion. As described below, a smoothing layer can be provided as an undercoating layer.

### Nonmagnetic Support

A known film in the form of a polyester such as polyethylene terephthalate or polyethylene naphthalate, polyolefins, cellulose triacetate, polycarbonate, polyamide, polyimide, polyamidoimide, polysulfone, polyaramide, aromatic polyamide, or polybenzooxazol can be employed as the nonmagnetic support. The use of a high-strength support such as polyethylene naphthalate or polyamide is desirable. As needed, laminated supports such as those disclosed in Japanese Unexamined Patent Publication (KOKAI) Heisei No. 3-224127, which is expressly incorporated herein by reference in its entirety, can be employed to vary the surface roughness of the magnetic surface and nonmagnetic support surface. These supports may be subjected beforehand to corona discharge treatment, plasma treatment, adhesion enhancing treatment, heat treatment, dust removal, and the like. An aluminum or glass support can also be employed as the support.

Of these, a polyester support (referred to simply as “polyester” hereinafter) is desirable. The polyester is desirably comprised of dicarboxylic acid and a diol, such as polyethylene terephthalate and polyethylene naphthalate.

Examples of the dicarboxylic acid component serving as the main structural component are: terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylethane dicarboxylic acid, cyclohexane dicarboxylic acid, diphenyl dicarboxylic acid, diphenylthioether dicarboxylic acid, diphenylketone dicarboxylic acid, and phenylindane dicarboxylic acid.

Examples of the diol component are: ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone, and cyclohexanediol.

Among polyesters employing the above compounds as main structural components, those comprising main structural components in the form of terephthalic acid and/or 2,6-naphthalene dicarboxylic acid as a dicarboxylic acid component, and ethylene glycol and/or 1,4-cyclohexane dimethanol as a diol component, are desirable from the perspectives of transparency, mechanical strength, dimensional stability, and the like.

Among these, polyesters comprising main structural components in the form of polyethylene terephthalate or polethylene-2,6-naphthalate; copolymer polyesters comprised of terephthalic acid, 2,6-naphthalene dicarboxylic acid, and ethylene glycol; and polyesters comprising main structural components in the form of mixtures of two or more of these polyesters are preferred. Polyesters comprising polyethylene-2,6-naphthalate as the main structural component are of even greater preference.

The polyester may be biaxially oriented, and may be a laminate with two or more layers.

Other copolymer components may be copolymerized and other polyesters may be mixed into the polyester. Examples are the dicarboxylic acid components and diol components given above by way of example, and polyesters comprised of them.

To prevent delamination when used in films, aromatic dicarboxylic acids having sulfonate groups or ester-forming derivatives thereof, dicarboxylic acids having polyoxyalkylene groups or ester-forming derivatives thereof, diols having polyoxyalkylene groups, or the like can be copolymerized in the polyester.

Among these, 5-sodiumsulfoisophthalic acid, 2-sodiumsulfoterephthalic acid, 4-sodiumsulfophthalic acid, 4-sodiumsulfo-2,6-naphthylene dicarboxylic acid, compounds in which the sodium in these compounds has been replaced with another metal (such as potassium or lithium), ammonium salt, phosphonium salt, or the like, ester-forming compounds thereof, polyethylene glycol, polytetramethylene glycol, polyethylene glycol-polypropylene glycol copolymers, compounds in which the two terminal hydroxy groups of these compounds have been oxidized or the like to form carboxyl groups, and the like are desirable from the perspectives of the polyester polymerization reaction and film transparency. The ratio of copolymerization for the above purpose is desirably 0.1 to 10 mol percent based on the dicarboxylic acid constituting the polyester.

Further, to increase heat resistance, a bisphenol compound or a compound having a naphthalene ring or cyclohexane ring can be copolymerized. The copolymerization ratio of the above compounds is desirably 1 to 20 mol percent based on the dicarboxylic acid constituting the polyester.

The above polyesters can be manufactured according to conventional known polyester manufacturing methods. An example is the direct esterification method, in which the dicarboxylic acid component is directly esterification reacted with the diol component. It is also possible to employ a transesterification in which a dialkyl ester is first employed as a dicarboxylic acid component to conduct a transesterification reaction with a diol component, and the product is then heated under reduced pressure to remove the excess diol component and conduct polymerization. In this process, transesterification catalysts or polymerization catalysts may be employed and heat-resistant stabilizers added as needed.

One or more of various additives such as anticoloring agents, oxidation inhibitors, crystal nucleus agents, slipping agents, stabilizers, antiblocking agents, UV absorbents, viscosity-regulating agents, defoaming transparency-promoting agents, antistatic agents, pH-regulating agents, dyes, pigments, and reaction-stopping agents can be added at any step during synthesis.

Filler can be added to the polyester. Examples of fillers are: inorganic powders such as spherical silica, colloidal silica, titanium oxide, and alumina, and organic fillers such as crosslinked polystyrene and silicone resin.

Further, to render the supports highly rigid, these materials can be highly oriented, and surface layers of metals, semimetals, and oxides thereof can be provided.

The nonmagnetic support is desirably 3 to 80 micrometers, preferably 3 to 50 micrometers, and more preferably, 3 to 10 micrometers in thickness. The nonmagnetic support with high smoothness is preferably employed. The average center surface roughness (Ra) of the support surface is desirably equal to or less than 6 nm, preferably equal to or less than 4 nm, more preferably 0.8 to 4 nm. The Ra is a value that is measured with an HD2000 made by WYKO.

Further, the Young's modulus of the nonmagnetic support is desirably equal to or greater than 6.0 GPa, preferably equal to or greater than 7.0 GPa, in the longitudinal and width directions.

### Layer Structure

In the magnetic recording medium of the present invention, the thickness of the nonmagnetic support preferably ranges from 3 to 80 micrometers, more preferably from 3 to 50 micrometers, further preferably from 3 to 10 micrometers, as set forth above. When an undercoating layer is provided between the nonmagnetic support and the nonmagnetic layer or the magnetic layer, the thickness of the undercoating layer ranges from, for example, 0.01 to 0.8 micrometer, preferably 0.02 to 0.6 micrometer.

An intermediate layer can be provided between the support and the nonmagnetic layer or the magnetic layer and/or between the support and the backcoat layer to improve smoothness. For example, the intermediate layer can be formed by coating and drying a coating liquid comprising a polymer on the surface of the nonmagnetic support, or by coating a coating liquid comprising a compound (radiation-curable compound) comprising intramolecular radiation-curable functional groups and then irradiating it with radiation to cure the coating liquid.

A radiation-curable compound having a number average molecular weight ranging from 200 to 2,000 is desirably employed. When the molecular weight is within the above range, the relatively low molecular weight can facilitate coating flow during the calendering step, increasing moldability and permitting the formation of a smooth coating.

A radiation-curable compound in the form of a bifunctional acrylate compound with the molecular weight of 200 to 2,000 is desirable. Bisphenol A, bisphenol F, hydrogenated bisphenol A, hydrogenated bisphenol F, and compounds obtained by adding acrylic acid or methacrylic acid to alkylene oxide adducts of these compounds are preferred.

The radiation-curable compound can be used in combination with a polymeric binder. Examples of the binder employed in combination are conventionally known thermoplastic resins, thermosetting resins, reactive resins, and mixtures thereof. When the radiation employed in the curing process is UV radiation, a polymerization initiator is desirably employed in combination. A known photoradical polymerization initiator, photocationic polymerization initiator, photoamine generator, or the like can be employed as the polymerization initiator.

A radiation-curable compound can also be employed in the nonmagnetic layer.

The thickness of the magnetic layer can be optimized based on the saturation magnetization of the head employed, the length of the head gap, and the recording signal band, and is normally 10 to 150 nm, preferably 20 to 120 nm, more preferably 30 to 100 nm, and further preferably 30 to 80 nm. The thickness variation (σ/δ) in the magnetic layer is preferably within ±50 percent, more preferably within ±30 percent. At least one magnetic layer is sufficient. The magnetic layer may be divided into two or more layers having different magnetic characteristics, and a known configuration relating to multilayered magnetic layer may be applied.

The thickness of the nonmagnetic layer ranges from, for example, 0.1 to 3.0 μm, preferably 0.3 to 2.0 μm. The nonmagnetic layer of the present invention is effective so long as it is substantially nonmagnetic. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercivity Hc of equal to or less than 7.96 kA/m (100 Oe), it being preferable not to have a residual magnetic flux density or coercivity at all.

### Backcoat Layer

A backcoat layer is desirably provided on the surface of the nonmagnetic support, opposite to the surface on which the magnetic layer is provided. The backcoat layer desirably comprises carbon black and inorganic powder. The formula of the magnetic layer or nonmagnetic layer can be applied to the binder and various additives of the backcoat layer. The formula of the nonmagnetic layer is preferred. The backcoat layer is preferably equal to or less than 0.9 micrometer, more preferably 0.1 to 0.7 micrometer, in thickness.

### Manufacturing Method

The magnetic recording medium of the present invention can be manufactured by a method comprising the steps of coating a nonmagnetic layer coating liquid and magnetic layer coating liquid on at least one surface of a nonmagnetic support to obtain a coated stock material; winding the coated stock material on a take-up roll; and unwinding the coated stock material that has been wound on the take-up roll and subjecting it to calendaring, for example.

The process for manufacturing coating liquids for forming magnetic and nonmagnetic layers normally comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these applications are incorporated herein by reference in their entirety. Further, glass beads may be employed to disperse the coating liquids for magnetic and nonmagnetic layers, with a dispersing medium with a high specific gravity such as zirconia beads, titania beads, and steel beads being suitable for use. The particle diameter and fill ratio of these dispersing media can be optimized for use. A known dispersing device may be employed.

In the method of manufacturing a magnetic recording medium, for example, a nonmagnetic layer coating liquid and a magnetic layer coating liquid can be multilayer-coated on the surface of the nonmagnetic support being running. Both a wet-on-wet method (simultaneous multilayer coating method) and a wet-on-dry method (successive multilayer coating method) can be employed. In the wet-on-wet method, a coating liquid for forming a nonmagnetic layer is coated, and while this coating is still wet, a coating liquid for forming a magnetic layer is coated thereover and dried. In the wet-on-dry method, a coating liquid for forming a nonmagnetic layer is coated and dried to form a nonmagnetic layer, and then a coating liquid for forming a magnetic layer is coated on the nonmagnetic layer and dried. The successive coating method makes it possible to obtain uniform boundary face between the magnetic layer and nonmagnetic layer to lower the thickness variation of the magnetic layer, resulting in improve S/N ratio; it is suited to high-densification.

The coating apparatus used to coat the magnetic layer coating liquid or nonmagnetic layer coating liquid can be an air doctor coater, blade coater, rod coater, extrusion coater, air knife coater, squeeze coater, impregnating coater, reverse roll coater, transfer roll coater, gravure coater, kiss coater, cast coater, spray coater, spin coater, or the like. Details of the coating apparatus are described in, for example, “The Most Recent Coating Techniques,” published by the Sogo Technology Center (Ltd.) (May 31, 1983), which is expressly incorporated herein by reference in its entirety.

The magnetic recording medium of the present invention can be a magnetic tape such as a video tape or computer tape, or a magnetic disk such as a flexible disk or hard disk. When the magnetic recording medium of the present invention is a magnetic tape, the coating layer that is formed by coating the magnetic layer coating liquid can be magnetic field orientation processed using cobalt magnets or solenoids on the ferromagnetic powder contained in the coating layer. When it is a disk, an adequately isotropic orientation can be achieved in some products without orientation using an orientation device, but the use of a known random orientation device in which cobalt magnets are alternately arranged diagonally, or alternating fields are applied by solenoids, is desirable. In the case of ferromagnetic metal powder, the term “isotropic orientation” generally refers to a two-dimensional in-plane random orientation, which is desirable, but can refer to a three-dimensional random orientation achieved by imparting a perpendicular component. Further, a known method, such as opposing magnets of opposite poles, can be employed to effect perpendicular orientation, thereby imparting an isotropic magnetic characteristic in the peripheral direction. Spin coating can be used to effect peripheral orientation. Perpendicular orientation is particularly desirable when conducting high-density recording.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material thus obtained can be temporarily wound on a take-up roll, and then unwound from the take-up roll and calendered.

For example, super calender rolls can be employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions in response to the smoothness of the surface of the coated stock material.

As for the calendaring conditions, the calender roll temperature preferably ranges from 60 to 100° C., more preferably 70 to 100° C., and further preferably 80 to 100° C. The pressure preferably ranges from 100 to 500 kg/cm (98 to 490 kN/m), more preferably 200 to 450 kg/cm (196 to 441 kN/m), and further preferably 300 to 400 kg/cm (294 to 392 kN/m). Taking into account the properties of a particulate medium, it is desirable to control the surface smoothness by means of the calender roll pressure and calender roll temperature. Generally, the calender roll pressure is reduced, or the calender roll temperature is lowered, to diminish the surface smoothness of the final product. Conversely, the calender roll pressure can be increased or the calender roll temperature can be raised to increase the surface smoothness of the final product. The surface smoothness can also be controlled by adjusting the calender roll temperature, calender roll speed, and calender roll tension.

Alternatively, the magnetic recording medium following the calendering step can be thermally processed to induce thermosetting. Such thermal processing can be suitably determined based on the blending formula of the magnetic layer coating liquid. The thermal processing temperature is, for example, 35 to 100° C., desirably 50 to 80° C. The thermal processing time is, for example, 12 to 72 hours, desirably 24 to 48 hours.

Rolls of a heat-resistant plastic such as epoxy, polyimide, polyamide, or polyamidoimide, can be employed as the calender rolls. Processing with metal rolls is also possible.

The surface roughness of the magnetic layer in the magnetic recording medium of the present invention, as an average center surface roughness, Ra, is desirably 1.0 to 3.0 nm, preferably 1.5 to 2.5 nm. The average center surface roughness Ra refers to a value measured for a sample area of 250 square micrometers (250 micrometers×250 micrometers) with an optical interference 3D profiler, the “TOPO-3D,” made by WYKO Corp. (Arizona, U.S.). The measured value is subjected to correction such as tilt correction, spherical surface correction, and cylindrical correction in accordance with JIS-B601. Since the above-described iron nitride powder can have good dispersibility and tends not to undergo oriented aggregation, it is possible to obtain a magnetic layer having a surface roughness falling within the above-stated range that has a highly smooth surface.

The magnetic recording medium obtained can be cut to desired size with a cutter or the like. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like are suitably selected.

### Physical Characteristics

The saturation magnetic flux density of the magnet layer is preferably 100 to 400 mT. The coercivity (Hc) of the magnetic layer is preferably 143 to 279 kA/m, more preferably 170 to 250 kA/m. Narrower coercivity distribution is preferable. The SFD and SFDr are preferably equal to or lower than 0.7, more preferably equal to or lower than 0.6, further preferably 0.35 to 0.60.

In the magnetic recording medium of the present invention, Mrδ, the product of residual magnetization Mr of the magnetic layer and the magnetic layer thickness δ, preferably ranges from 2 to 30 mT·μm, more preferably 3 to 25 mT·μm. The Mrδ exceeding 30 mT·μm is undesirable because of saturation of MR head employed, and at less than 2 mT·μm, sensitivity may be small and it may become difficult to ensure adequate S/N ratio.

The coefficient of friction of the magnetic recording medium relative to the head is preferably equal to or less than 0.5 and more preferably equal to or less than 0.3 at temperatures ranging from −10° C. to 40° C. and humidity ranging from 0 percent to 95 percent, the surface resistivity on the magnetic surface preferably ranges from 10⁴ to 10⁸ ohm/sq, and the charge potential preferably ranges from −500 V to +500 V. The modulus of elasticity at 0.5 percent extension of the magnetic layer preferably ranges from 0.98 to 19.6 GPa (approximately 100 to 2,000 kg/mm²) in each in-plane direction. The breaking strength preferably ranges from 98 to 686 MPa (approximately 10 to 70 kg/mm²). The modulus of elasticity of the magnetic recording medium preferably ranges from 0.98 to 14.7 GPa (approximately 100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature of the magnetic layer (i.e., the temperature at which the loss elastic modulus of dynamic viscoelasticity peaks as measured at 110 Hz) of the magnetic layer is preferably 50 to 180° C., and that of the lower layer preferably ranges from 0 to 180° C. The loss elastic modulus preferably falls within a range of 1×10⁷ to 8×10⁸ Pa (1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by 10 percent or less, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 40 volume percent, more preferably equal to or less than 30 volume percent. Although a low void ratio is preferable for attaining high output, there are some cases in which it is better to ensure a certain level based on the object. For example, in many cases, larger void ratio permits preferred running durability in disk media in which repeat use is important.

Physical properties of the nonmagnetic layer and magnetic layer may be varied based on the objective in the magnetic recording medium of the present invention. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

Normally, two units denoting linear recording density are employed: fci and bpi. “fci” denotes the density that is physically recorded on the medium as the number of bit inverts per inch, while “bpi” denotes the number of bits per inch, including signal processing, and is system-dependent. Thus, the fci is normally employed for pure performance evaluation of a medium. The magnetic recording medium of the present invention can exhibit good high-density recording characteristics, and can be exhibit excellent recording characteristics in high-density recording region especially by subjecting to perpendicular orientation. The desirable linear recording density range in the course of recording a signal on the magnetic recording medium of the present invention is 100 to 400 kfci, with 175 to 400 kfci being preferred. In systems actually in use, this depends on signal processing, and cannot be determined once and for all. As a general guideline, performance is reflected by an fci of 0.5 to one times the bpi. Thus, a range of 200 to 800 kbpi is desirable, 350 to 800 kbpi being preferred. In order to reproduce magnetic signals that have been recorded at high density with good S/N ratio, a magnetoresistive head (MR head) is preferably employed as a reproduction head.

### EXAMPLES

The present invention will be described in detail below based on examples. However, the present invention is not limited to the examples. The term “parts” given in Examples are weight parts unless specifically stated otherwise.

### Examples 1-1 to 1-5

Formation of Starting Material Particles

A 0.25 mol quantity of FeSO₄.7H₂O and 0.50 mol quantity of Fe₂(SO₄)₃.9H₂O were dissolved in 1,500 g of water to prepare an iron salt aqueous solution. Next, 2.05 mol quantity of ammonia water were used to prepare a 1,500 g aqueous solution. While stirring the iron salt aqueous solution, the ammonia water aqueous solution was added at room temperature (about 25° C.) and the mixture was stirred for 20 minutes. The mixture was then heated to 60° C., producing Fe₃O₄ particles. The solution was cooled and the precipitate was filtered and washed with water to recover the particles that had been produced.

The Fe₃O₄ particles obtained were charged to an autoclave, hydrothermally treated for 3 hours at the temperature indicated in Table 1, and washed with water. The Fe₃O₄ particles obtained were roughly cubic in shape. The average size of the particles obtained by hydrothermal treatment at 150° C. was 14 nm, and the average size of particles obtained by hydrothermal treatment at 170° C. was 19 nm.

(2) Forming Iron Nitride Powder

A 100 g quantity of the Fe₃O₄ particles formed in (1) above was dispersed in 1,500 mL of pure water with an ultrasonic disperser. Relative to the Fe in the Fe₃O₄ contained in the dispersion, Al corresponding to the Al/Fe (atomic percent) shown in Table 1 was added as an aluminum chloride solution and the pH was adjusted to 7.5 by adding an ammonia aqueous solution (concentration: 10 weight percent) while stirring. Fe₃O₄ particles were precipitated out, the supernatant was removed, and water washing was conducted three times in repetition. Relative to the Fe in the Fe₃O₄, yttrium corresponding to the Y/Fe (atomic percent) shown in Table 1 was added as an yttrium nitrate aqueous solution. While stirring, an ammonia aqueous solution (concentration: 10 weight percent) was added, the pH was adjusted to 7.5, and an Al and Y compound was adhered to the surface of the Fe₃O₄ particles (sintering-preventing treatment).

Following adhesion treatment, the Fe₃O₄ particles were washed with water, filtered, and dried. They were heated to and maintained at 350° C. for 60 minutes in air, and then annealed for 2 hours at 650° C. Following nitrogen substitution, the temperature was changed to 480° C. and the particles were reduced for 4 hours in a pure hydrogen atmosphere, yielding ferromagnetic metal powder containing Al and Y. The temperature was lowered to 150° C. under a hydrogen flow. While maintaining at 150° C., ammonia gas was employed for 30 hours of nitrogenation. The ammonia gas was replaced with nitrogen gas, the temperature was lowered to 50° C., and the particle surface was gradually oxidized with a mixed gas containing about 0.1 to 5 volume percent of oxygen in nitrogen. The concentration of the oxygen was controlled so that the gas temperature did not exceed 90° C.

(3) Cobalt-Containing Ferrite Adhesion Processing

A 5 weight percent quantity of the magnetic powder obtained in (2) above was added to a pH 10.5 sodium hydroxide aqueous solution and the mixture was dispersed in a sand grinder. CoSO₂.7H₂O corresponding to 4 atomic percent as Co/Fe relative to the iron in the dispersion and a double quantity of FeSO₄.7H₂O relative to the Co were dissolved in water and added while bubbling nitrogen to the dispersion as it was being stirred. Sodium hydroxide aqueous solution was added to the dispersion to an OH concentration of 2N. The mixture was then heated and maintained for 1 hour at 100° C. The bubbling gas was switched to air and maintained for 3 hours. Following the reaction, the mixture was cooled to room temperature (about 25° C.), filtered, washed with water, and dried in an atmosphere with a 4 percent oxygen concentration to manufacture a compound magnetic powder.

### Examples 1-6 and 1-7

(1) Formation of Starting Material Particles

A 0.25 mol quantity of FeSO₄.7H₂O and 0.50 mol quantity of Fe₂(SO₄)₃.9H₂O were dissolved in 1,500 g of water to prepare an iron salt aqueous solution. Next, 2.05 mol quantity of sodium hydroxide were dissolved in 1,500 g of water. The sodium hydroxide aqueous solution was added to the iron salt aqueous solution at room temperature (about 25° C.) and the mixture was stirred for 20 minutes and heated to 60° C. to produce Fe₃O₄ particles. The solution was cooled, and the precipitate was filtered and washed with water to recover the particles that had been produced.

The Fe₃O₄ particles obtained were charged to an autoclave, hydrothermally treated for 3 hours at 160° C., and washed with water. The particles were then heated to 300° C. in air to obtain γ-Fe₂O₃. The temperature was raised to 650° C. to obtain α-Fe₂O₃ and maintained for 2 hours. The α-Fe₂O₃ particles obtained were spherical to elliptical in shape. The average particle size was 17 nm.

(2) Formation of Iron Nitride Powder

A 100 g quantity of the α-Fe₂O₃ particles obtained was dispersed in 3,000 mL of water, the supernatant was removed, and the Na fraction that precipitated out of the α-Fe₂O₃ was removed. Next, relative to the iron in the α-Fe₂O₃, Al was added as an aluminum chloride aqueous solution to achieve the Al/Fe ratio indicated in Table 1 and yttrium was added as an yttrium nitrate aqueous solution to achieve the Y/Fe ratio indicated in Table 1. The mixture was neutralized with an ammonia aqueous solution (concentration: 10 weight percent), the hydroxide of Al and Y was adhered to the surface (sintering-preventing treatment), and following the adhesion treatment, the particles were filtered, washed with water, and dried.

Next, hot reduction was conducted for 2 hours at 450° C. in hydrogen gas to obtain ferromagnetic metal powder. Under a hydrogen gas flow, the temperature was lowered to 150° C., the gas was replaced with ammonia gas, and while maintaining 150° C., the nitrogenation reaction was conducted for 30 hours. The gas was switched to nitrogen gas, the temperature was lowered to 50° C., and the particle surface was gradually oxidized with a mixed gas containing about 0.1 to 5 volume percent of oxygen in nitrogen. The concentration of oxygen was controlled so that the temperature of the gas did not exceed 90° C.

(3) Cobalt-Containing Ferrite Adhesion Treatment

The magnetic powder obtained in (2) above was added to 5 weight percent to a pH 11 sodium hydroxide aqueous solution and the mixture was dispersed in a sand grinder. Relative to the iron in the dispersion, CoSO₂.7H₂O corresponding to 2 atomic percent as Co/Fe and a triple quantity of FeSO₄.7H₂O relative to the Co were dissolved in water and added while bubbling nitrogen to the dispersion as it was being stirred. Sodium hydroxide aqueous solution was added to the dispersion to an OH concentration of 1.5N. Next, the mixture was heated and maintained at 100° C. for 1 hour, the bubbling gas was switched to air, and this was maintained for 3 hours. Following the reaction, the mixture was cooled to room temperature (about 25° C.), filtered, washed with water, and dried in an atmosphere with a 4 percent oxygen concentration to manufacture compound magnetic powder.

### Comparative Example 1-1

With the exception that no adhesion treatment with cobalt-containing ferrite was conducted, magnetic powder was manufactured by the same method as in Example 1-1.

### Comparative Example 1-2

With the exception that no adhesion treatment with cobalt-containing ferrite was conducted, magnetic powder was manufactured by the same method as in Example 1-2.

### Comparative Example 1-3

With the exception that no adhesion treatment with cobalt-containing ferrite was conducted, magnetic powder was manufactured by the same method as in Example 1-3.

### Comparative Example 1-4

With the exception that no adhesion treatment with cobalt-containing ferrite was conducted, magnetic powder was manufactured by the same method as in Example 1-4.

### Comparative Example 1-5

With the exception that no adhesion treatment with cobalt-containing ferrite was conducted, magnetic powder was manufactured by the same method as in Example 1-5.

### Comparative Example 1-6

With the exception that no adhesion treatment with cobalt-containing ferrite was conducted, magnetic powder was manufactured by the same method as in Example 1-6.

### Comparative Example 1-7

With the exception that no adhesion treatment with cobalt-containing ferrite was conducted, magnetic powder was manufactured by the same method as in Example 1-7.

### Confirmation of Iron Nitride Main Phase

X-ray diffraction of the iron nitride powder obtained produced a profile indicating an Fe₁₆N₂ phase. The nitrogen content was measured with fluorescent X-rays, confirming that it was within a range of 7.0 to 14 atomic percent relative to iron. Based on the X-ray diffraction results and nitrogen content determined by fluorescent X-rays, Fe₁₆N₂ was confirmed to be the principal component of the iron nitride powder formed.

### Confirmation of Coating Layer

Observation of the iron nitride particles formed in Examples 1-1 to 1-7 by high-resolution analytical transmission electron microscope revealed the near complete absence of free particles. Based on this result, it could be inferred that CoFe₂O₄ had been epitaxially grown on the gradually oxidized iron oxide surface of the Fe₁₆N₂ by adhesion processing with cobalt-containing ferrite. From the lack of any major difference in particle size or specific surface area relative to the comparative examples that were not subjected to cobalt-containing ferrite adhesion processing, it was determined that free microparticles had not been produced. The various iron nitride particles were pressed and the surface elements thereof were analyzed by X-ray photoelectron spectroscopy, resulting in the detection of Al, Y, Co, and Fe. When elemental analysis was conducted while etching, the Al, Y, and C attenuated, becoming constant values. From these results, it was determined that sintering-preventing agent and cobalt-containing ferrite had been produced on the surface of the iron nitride particles.

### Evaluation of Iron Nitride Particles

(1) Measurement of Average Particle Diameter

The average particle diameter of 500 iron nitride particles was measured by high-resolution analytical transmission electron microscope (at 500,000-fold magnification). The results are given in Table 1.

(2) Measurement of Surface Area

The surface area was calculated as the specific surface area by BET method. The results are given in Table 1.

(3) Aluminum and Yttrium Contents

The nitrogen, aluminum, and yttrium contents of the iron nitride powder were measured with fluorescent X-rays. The presence of aluminum and yttrium corresponding to the quantities added was confirmed.

(4) Magnetic Characteristics

A 796 kA/m (10 kOe) magnetic field was applied to each of the iron nitride powders to measure the magnetic characteristics thereof. The results are given in Table 1.

(5) Sintering-Preventing Agent Coverage Rate

Based on the quantities of yttrium and aluminum compounds added as sintering-preventing agents, the sintering-preventing agent coverage rate was calculated for a single layer of Y₂O₃ and α-Al₂O₃ unit lattice on the particle surface following the sintering-preventing treatment. The results are given in Table 1.

(6) Demagnetization Ratio

Magnetic powder (magnetization: MO) that had been magnetically measured was stored for 7 days in a thermostatic chamber at 60° C. and 90 percent RH, then subjected to the same magnetic measurement as in (4) above to measure the sample magnetization (M). The demagnetization was calculated as (M/M₀−1)×100.

TABLE 1

| | | | | | | | | Particle | | |
|---|---|---|---|---|---|---|---|---|---|---|
| | | | | | | | | diameter | Specific | |
| | Hydrothermal | | | Surface | | | | of the | surface | Demagnetization ratio |
| | treatment | Al/Fe | Y/Fe | coverage | Adhesion | Hc | σs | product | area | (%) |
| No | temp. (° C.) | (at %) | (at %) | rate (%) | treatment | (kA/m) | (A · m²/kg) | (nm) | (m²/g) | 7 days |
| Ex. 1-1 | 150 | 9.5 | 2.3 | 65 | Conducted | 162.5 | 57.5 | 10.8 | 74.2 | −9.5 |
| Ex. 1-2 | 150 | 4.75 | 3.6 | 50 | Conducted | 170.8 | 60.7 | 11.4 | 68.1 | −8.8 |
| Ex. 1-3 | 170 | 4.75 | 5.5 | 86 | Conducted | 208.8 | 105.3 | 17.5 | 45.8 | −8.3 |
| Ex. 1-4 | 170 | 4.75 | 3.6 | 65 | Conducted | 210.3 | 103.6 | 15.3 | 52.4 | −8.1 |
| Ex. 1-5 | 170 | 9.5 | 2.3 | 108 | Conducted | 213.6 | 108.7 | 16.8 | 48.9 | −7.5 |
| Ex. 1-6 | 160 | 4.75 | 5.5 | 70 | Conducted | 183.6 | 88.5 | 14.2 | 56.4 | −7.9 |
| Ex. 1-7 | 160 | 9.5 | 2.3 | 91 | Conducted | 190.4 | 90.4 | 15.1 | 53.0 | −8.2 |
| Comp. Ex. 1-1 | 150 | 9.5 | 2.3 | 65 | Not conducted | 161.8 | 55.5 | 10.8 | 74.9 | −22.6 |
| Comp. Ex. 1-2 | 150 | 4.75 | 3.6 | 50 | Not conducted | 168.5 | 57.5 | 11.3 | 68.5 | −24.5 |
| Comp. Ex. 1-3 | 170 | 4.75 | 5.5 | 86 | Not conducted | 205.5 | 100.8 | 17.6 | 45.3 | −20.5 |
| Comp. Ex. 1-4 | 170 | 4.75 | 3.6 | 65 | Not conducted | 207.4 | 99.4 | 15.2 | 52.8 | −23.3 |
| Comp. Ex. 1-5 | 170 | 9.5 | 2.3 | 108 | Not conducted | 210.3 | 102.7 | 16.8 | 45.1 | −19.6 |
| Comp. Ex. 1-6 | 160 | 4.75 | 5.5 | 70 | Not conducted | 181.2 | 83.6 | 14.2 | 55.4 | −30.5 |
| Comp. Ex. 1-7 | 160 | 9.5 | 2.3 | 91 | Not conducted | 187.6 | 86.2 | 15.2 | 53.6 | −28.7 |

### Examples 2-1 to 2-7, Comparative Examples 2-1 to 2-7

(Magnetic layer coating liquid)

| | |
|---|---|
| Iron nitride powder (indicated in Table 2) | 100 parts |
| Binder resin | |
| Vinyl chloride copolymer | 13 parts |
| (—SO₃K group content: 1 × 10⁻⁴ eq/g, | |
| degree of polymerization: 300) | |
| Polyester polyurethane resin | 4 parts |
| (Neopentylglycol/caprolactone polyol/MDI = 0.9/2.6/1, | |
| —SO₃Na group content: 1 × 10⁻⁴ eq/g) | |
| α-alumina (average particle diameter: 0.08 micrometer) | 5 parts |
| Carbon black | 2 parts |
| (average particle diameter: 40 nm, variation | |
| coefficient of particle diameter: 200%) | |
| Phenylphosphonic acid | 4 parts |
| Butyl stearate | 3 parts |
| Stearic acid | 3 parts |
| Mixed solvent of methyl ethyl ketone and cyclohexanone (1:1) | 280 parts |

Of the above components, the iron nitride powder, carbon black, Phenylphosphonic acid, vinyl chloride copolymer, and 130 parts of a 1:1 mixed solvent of methyl ethyl ketone and cyclohexanone were kneaded in a kneader, the remaining above components were admixed, and the mixture was dispersed for 1 hour in a sand grinder using zirconia beads 0.5 mm in diameter. To the dispersion obtained were added 6 parts of polyisocyanate followed by 20 parts of a 1:1 mixed solvent of methyl ethyl ketone and cyclohexanone. The mixture was filtered with a filter having an average pore size of 1 micrometer to prepare a magnetic layer coating liquid.

(Nonmagnetic layer coating liquid)

| | |
|---|---|
| Acicular hematite | 80 parts |
| (Specific surface area by BET method: | |
| 65 m²/g, average major axis length: | |
| 0.10 micrometer, average acicular ratio: | |
| 7, pH: 8.8, aluminum treatment: 1 weight | |
| percent as Al₂O₃) | |
| Carbon black | 20 parts |
| (Average particle diameter: 17 nm, | |
| DBP oil absorption capacity: 80 ml/100 g, | |
| specific surface area by BET method: | |
| 240 m²/g, pH: 7.5) | |
| Binder resin | |
| Vinyl chloride copolymer | 13 parts |
| (—SO₃K group content: 1 × 10⁻⁴ eq/g, | |
| degree of polymerization: 300) | |
| Polyester polyurethane resin | 5 parts |
| (Neopentylglycol/caprolactone polyol/MDI = 0.9/2.6/1, | |
| —SO₃Na group content: 1 × 10⁻⁴ eq/g) | |
| Phenylphosphonic acid | 4 parts |
| Butyl stearate | 3 parts |
| Stearic acid | 3 parts |
| Mixed solvent of methyl ethyl ketone and cyclohexanone (8:2) | 280 parts |

Of the above components, the acicular hematite, phenylphosphonic acid, carbon black, vinyl chloride copolymer, and 130 parts of an 8:2 mixed solvent of methyl ethyl ketone and cyclohexanone were kneaded in a kneader, the remaining above components were admixed, and the mixture was dispersed for 1 hour in a sand grinder with zirconia beads 1 mm in diameter to prepare a dispersion. To the dispersion obtained were added 10 parts of isocyanate and 30 parts of cyclohexanone. The mixture was filtered with a filter having an average pore size of 1 micrometer to prepare a nonmagnetic layer coating liquid.

The nonmagnetic layer coating liquid was coated in a quantity calculated to yield a dry thickness of 2.0 micrometers to a polyethylene terephthalate support 6.5 micrometers in thickness and dried to form a nonmagnetic layer. Using a separate head having a two-slit coating element, the magnetic layer coating liquid was fed through and coated by the front slit in a quantity calculated to produce a magnetic layer 250 nm in thickness on the nonmagnetic layer that had been formed, and the excess quantity of coating liquid was aspired through the rear slit to yield a magnetic layer 80 nm or less in thickness following drying. While the magnetic layer was still wet, the product was passed between longitudinally-orienting magnets in the form of rare earth magnets (with a surface magnetic flux of 500 mT), and then between solenoid magnets (with a magnetic flux density of 500 mT). Drying to a degree at which the orientation would not revert was conducted within the solenoids. The magnetic layer was then dried and wound in a drying element.

Next, on the opposite side of the nonmagnetic support from the side on which the nonmagnetic lower layer and magnetic layer had been formed, a backcoat layer coating liquid was coated and dried in a quantity calculated to yield a backcoat layer 700 nm in thickness following drying and calendering. The backcoat layer coating liquid was prepared by dispersing the backcoat layer coating liquid components listed below in a sand mill to achieve a retention time of 45 minutes, adding 8.5 parts of polyisocyanate, stirring, and filtering.

### <Backcoat Layer Coating Liquid Components>

Carbon black (average particle diameter: 25 nm): 40.5 parts

Carbon black (average particle diameter: 350 nm): 0.5 parts

Barium sulfate: 4 parts

Nitrocellulose: 28 parts

SO₃Na group-containing polyurethane resin: 20 parts

Cyclohexanone: 100 parts

Toluene: 100 parts

Methyl ethyl ketone: 100 parts

The magnetic recording medium stock sheet thus obtained was processed to a mirror finish with a seven-stage calender (temperature 80° C., linear pressure 300 kg/cm) and subjected to a thermal treatment for 24 hours at 60° C. and 40 percent RH. Subsequently, the sheet was cut to a ½ inch width, and while being run at a speed of 100 m/min, the magnetic layer surface was polished with a diamond wheel (rotational speed+150 percent, winding angle 30°) to produce magnetic tape.

### Measurement Methods

(1) Electromagnetic Characteristics

The electromagnetic characteristics were measured by the following method.

A compound GMR head with a recording track width of 1.5 micrometers, a reproduction track width of 0.75 micrometers, and a distance between shields of 0.15 micrometer was mounted on a drum tester. The relative speed between tape and head was set to 10.2 m/s, an optimal recording current was determined based on an input/output characteristic of λ=0.15 micrometer, and a signal (λ=0.15 micrometer) was recorded and reproduced with this current. The C/N ratio was considered to be the ratio of the peak of the reproduction carrier to the demagnetization noise, and the resolution band width of the spectral analyzer was set to 100 kHz. The electromagnetic characteristics are given in Table 2 as values relative to the tape medium of Comparative Example 2-2.

(2) Magnetic Characteristics

The magnetic characteristics were measured at an applied magnetic field of 796 kA/m with a vibrating sample magnetometer.

(3) Average Thickness 8 of the Magnetic Layer

The average thickness 8 of the magnetic layer was obtained by (i) and (ii) below.

(i) Obtaining a Cross-Sectional Image of the Magnetic Tape

Ultrathin cross-sectional slices (slice thickness: about 80 to 100 nm) running parallel to the longitudinal direction of the tape were cut by the ultramicrotome method from an embedded block. Cross-sections of the magnetic tape in the cross-sectional ultrathin slices that had been cut were photographed with a transmission electron microscope (TEM H-9000 made by Hitachi) at a magnification of 100,000-fold continuously in the longitudinal direction of the tape centered on the boundary between the magnetic layer and nonmagnetic layer in 25 to 30 micrometer segments to obtain a continuous cross-sectional image of the magnetic tape.

(ii) Calculating the Average Thickness 6 of the Magnetic Layer

From the continuous photographs obtained in (i) above, lines were drawn by eye at the surface of the magnetic layer and the boundary between the magnetic layer and nonmagnetic layer, and the magnetic layer was trimmed. The trimmed magnetic layer line was then inputted with a scanner and the average thickness δ of the magnetic layer was calculated by image processing the width between the magnetic layer surface and the boundary between the magnetic layer and the nonmagnetic layer. The image processing was conducted with a KS Imaging Systems Ver. 3 made by Carl Zeiss by measuring the magnetic layer thickness width at about 2,100 points at intervals of 12.5 nm in the longitudinal direction of the magnetic layer. Scale correction during image input by scanner and image analysis was conducted with a line with an actual size of 2 cm. The magnetic tapes of both Examples and Comparative Examples had an average magnetic layer thickness 6 of 80 nm.

(4) Surface Roughness of the Magnetic Layer

A sample area of 250 square micrometers was measured with an optical interference 3D profiler, the “TOPO-3D,” made by WYKO Corp. (Arizona, U.S.). In calculating the measured value, correction such as tilt correction, spherical surface correction, and cylindrical correction was conducted in accordance with JIS-B601. The average center surface roughness Ra was adopted as the surface roughness.

(5) Demagnetization Ratio

Magnetic recording medium sheets (magnetization M₀), manufactured from the same stock material as the tape employed to evaluate electromagnetic characteristics in (2) above, were stored in a thermostatic chamber at 60° C. and 90 percent RH for 7 days and 28 days, after which magnetic measurement was conducted in the same manner as in (2) above. The magnetization (M) of the samples was measured, and the demagnetization loss ratio was calculated as (M/M₀−1)×100.

The results are given in Table 2 above.

TABLE 2

| | No. of | | | | | | | | | |
|---|---|---|---|---|---|---|---|---|---|---|
| | magnetic | | SQ in | | | | | | Demagnetization | Demagnetization |
| | material | Hc | longitudinal | | Mr · δ | SRa | Output | C/N | ratio (%) | ratio (%) |
| No | employed | (kA/m) | direction | SFD | (mT · μm) | (nm) | (dB) | (dB) | 7 days | 28 days |
| Ex. 2-1 | Ex. 1-1 | 14.5 | 0.81 | 0.55 | 11.7 | 2.3 | 0.7 | 0.8 | −6.8 | −13.5 |
| Ex. 2-2 | Ex. 1-2 | 15.2 | 0.83 | 0.52 | 12.2 | 2.2 | 0.8 | 0.9 | −6.5 | −13.1 |
| Ex. 2-3 | Ex. 1-3 | 17.6 | 0.84 | 0.49 | 19.4 | 2.2 | 1.3 | 1.2 | −6.1 | −11.9 |
| Ex. 2-4 | Ex. 1-4 | 17.9 | 0.84 | 0.47 | 19.1 | 2.1 | 1.5 | 1.5 | −4.9 | −9.7 |
| Ex. 2-5 | Ex. 1-5 | 18.7 | 0.85 | 0.53 | 20.4 | 1.9 | 1.7 | 1.6 | −4.4 | −8.8 |
| Ex. 2-6 | Ex. 1-6 | 16.3 | 0.82 | 0.53 | 15.7 | 2.1 | 1.2 | 1.1 | −5.1 | −10.5 |
| Ex. 2-7 | Ex. 1-7 | 16.8 | 0.82 | 0.55 | 16.4 | 2.2 | 1.1 | 0.9 | −5.3 | −10.8 |
| Comp. Ex. 2-1 | Comp. Ex. 1-2 | 14.7 | 0.77 | 0.98 | 10.5 | 2.5 | −1.1 | −0.8 | −7.5 | −22.5 |
| Comp. Ex. 2-2 | Comp. Ex. 1-3 | 17.9 | 0.79 | 0.95 | 17.1 | 2.5 | 0.0 | 0.0 | −7.2 | −21.6 |
| Comp. Ex. 2-3 | Comp. Ex. 1-5 | 18.2 | 0.78 | 1.04 | 17.3 | 2.6 | −0.3 | −0.5 | −6.8 | −22.7 |
| Comp. Ex. 2-4 | Comp. Ex. 1-7 | 16.2 | 0.77 | 1.12 | 14.1 | 2.5 | −0.6 | −0.7 | −16.3 | −35.6 |

### Evaluation Results

The iron nitride powders of Examples 1-1 to 1-7 had small particle size and exhibited little demagnetization following storage. As shown in Table 2, use of the iron nitride powders of Examples 1-1 to 1-7 yielded magnetic recording media having good magnetic characteristics and affording good stability over time.

The present invention can provide a magnetic recording medium with a good Hc distribution and good surface smoothness that can be employed in high-density recording.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. An iron nitride powder, which is comprised chiefly of Fe₁₆N₂ and comprises, on at least a portion of the powder surface, a coating layer comprising at least one element selected from the group consisting of rare earth metal elements, aluminum, and silicon, and cobalt-containing ferrite having a composition denoted by (CoₓFe₁₋ₓ)Fe₂O₄, wherein 0<x≦1.

2. The iron nitride powder according to claim 1, which has an average particle diameter ranging from 10 to 25 nm.

3. The iron nitride powder according to claim 1, which has a coercivity ranging from 143 to 279 kA/m.

4. The iron nitride powder according to claim 1, which has a saturation magnetization ranging from 55 to 110 A—m²/kg.

5. A method of manufacturing iron nitride powders, comprising:
subjecting iron oxide powders and/or iron hydroxide powders to a sintering prevention treatment, a reduction, and a nitrogenation, in this order, wherein
the sintering prevention treatment is conducted so that upon completion of the sintering preventing treatment, a sintering-preventing agent coverage rate on the surface of the iron nitride powder is equal to or more than 50 percent but less than 100 percent, and the method further comprising:
adhering cobalt-containing ferrite having a composition denoted by (CoₓFe₁₋ₓ) Fe₂O₄, wherein 0<x≦1, on the surface of the powder following the nitrogenation.

6. A magnetic recording medium comprising a magnetic layer comprising a ferromagnetic powder and a binder on a nonmagnetic support, wherein
the ferromagnetic powder is the iron nitride powder according to claim 1.

7. A magnetic recording medium comprising a magnetic layer comprising a ferromagnetic powder and a binder on a nonmagnetic support, wherein
the ferromagnetic powder is the iron nitride powder manufactured by the method according to claim 5.
